(19) United States
(12) Patent Application Publication
(10) Pub. No.: US 2006/0040115 A1
(43) Pub. Date: Feb. 23, 2006

(54) Film

(75) Inventors: Katsuyuki Watanabe, Shizuoka (JP); Shiro Tan, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/204,445

(22) Filed: Aug. 16, 2005

(30) Foreign Application Priority Data
Aug. 18, 2004 (JP) P.2004-238403
Aug. 18, 2004 (JP) P.2004-238404
Aug. 31, 2004 (JP) P.2004-252216
Aug. 4, 2005 (JP) P.2005-226833

(51) Int. Cl. B32B 9/04; C23C 8/00

(52) U.S. Cl. 428/447; 427/585

(57) ABSTRACT

A film formed by chemical vapor deposition of a diamantane or adamantane compound having a particular substituent or a composition containing the compound.

### BACKGROUND OF THE INVENTION

1. Field of the Invention

The present invention relates to a film, and particularly to an insulating film for multilayer interconnection in a semiconductor integrated circuit apparatus.

2. Description of the Related Art

In the field of electronic materials, recently as the integration, multifunctionalization, and performance thereof are advanced, the circuit resistance and the wiring condenser capacity are increased, resulting in increment in power consumption and delay time. Particularly the increase of the delay time is a great factor for decline of signal speed and occurrence of cross talk in devices, whereby there is demand for reducing the parasitic resistance or parasitic capacity, thereby decreasing the delay time to speed up the devices. Concrete attempts to reduce the parasitic capacity include coating a peripheral part of the wiring with a low-dielectric interlayer insulating film. The interlayer insulating films are required to have excellent heat resistance against film forming processes in the production of mount boards and after processes such as chip connection and pinning, and chemical resistance against wet processes. Further, in recent years, low-resistant Cu wirings are being used instead of Al wirings, and flattening processes by CMP (Chemical Mechanical Polishing) are widely used in accordance therewith, whereby the films are required to have high mechanical strength to be resistant to the processes.

Silicon oxide films are conventionally used as the interlayer insulating films. However, the silicon oxide films have relative dielectric constants of approximately 4 to 4.5, and the interlayer insulating films are required to have lower dielectric constants. Though fluorine-added silicon oxide films, low-dielectric SOG films, and organic polymer films have been proposed as the interlayer insulating films with relative dielectric constants lower than those of the silicon oxide films, most of the films have dielectric constants of 2.6 or more in the state of nonporous bulk. Porous films have been proposed as lower-dielectric insulating films. In the porous films, the volume of pores (the porosity) is increased to lower the dielectric constant. However, when the porosity is increased, the mechanical properties such as elasticity, hardness, and adhesion are significantly deteriorated, peeling of the resultant film, etc. is disadvantageously caused in CMP for forming the copper wirings.

Thus, organic polymer films comprising adamantane having diamond structures, etc. have recently been proposed to overcome the problem (JP-A-2004-18593 and JP-A-2003-252982) Saturated hydrocarbons such as adamantane are poorer in molecular polarizability than aromatic hydrocarbons, to show lower dielectric constants. However, the insulating film disclosed in JP-A-2004-18593 has a polyoxazole structure containing nitrogen and oxygen with high polarity, and thereby shows a high polarizability to increase the relative dielectric constant and hygroscopicity. Further, though a method of forming an insulating film comprising polyadamantane ether by chemical vapor deposition is disclosed in JP-A-2003-252982, the ratio of oxygen atoms to total carbon atoms forming the film is high, so that the method has a limitation on lowering the dielectric constant.

### SUMMARY OF THE INVENTION

The present invention relates to a film, particularly an insulating film, to solve the above problem, and more specifically relates to a low-dielectric insulating film useful for multilayer interconnection in a semiconductor integrated circuit apparatus.

The inventors have found that the above problem can be solved by the following constitution of (1) to (3).

(1) A film obtained by a chemical vapor deposition of a compound represented by any one of formula (Ia) to (Ic) or a composition containing at least the compound represented by any one of formula (Ia) to (Ic):

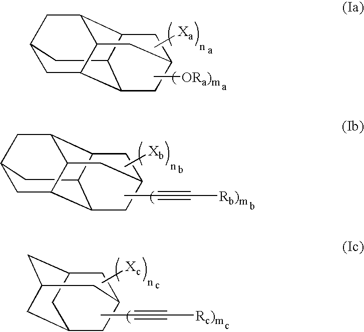

in formula (Ia), Rₐ represents a hydrogen atom, an alkyl group or a silyl group;

mₐ represents an integer of 1 to 14;

Xₐ represents a halogen atom, an alkyl group, an alkenyl group, an aryl group or a silyl group; and

nₐ represents an integer of 0 to 14, and when a compound includes a plurality of Rₐ's or a plurality of Xₐ's, the plurality of Rₐ's or the plurality of Xₐ's may be the same or different respectively,

in formula (Ib), R_{b} represents a hydrogen atom, an alkyl group, an alkenyl group, an alkynyl group, an aryl group or a silyl group;

m_{b} represents an integer of 1 to 14;

X_{b} represents a halogen atom, an alkyl group, an alkenyl group, an aryl group or a silyl group; and

n_{b} represents an integer of 0 to 14, and when a compound includes a plurality of R_{b}'s or a plurality of X_{b}'s, the plurality of R_{b}'s or the plurality of X_{b}'s may be the same or different respectively,

in formula (Ic), R_{c} represents a hydrogen atom, an alkyl group, an aryl group or a silyl group;

m_{c} represents an integer of 1 to 3;

X_{c} represents a halogen atom, an alkyl group, an alkenyl group, an aryl group or a silyl group; and

n_{c} represents an integer of 0 to 9, and when a compound includes a plurality of R_{c}'s or a plurality of X_{c}'s, the plurality of R_{c}'s or the plurality of X_{c}'s may be the same or different respectively.

(2) The film as described in (1) above,

wherein the chemical vapor deposition comprises a thermal polymerization reaction of the compound represented by any one of formula (Ia) to (Ic).

(3) The film as described in (1) above,

wherein the chemical vapor deposition comprises a plasma polymerization reaction of the compound represented by any one of formula (Ia) to (Ic).

### BRIEF DESCRIPTION OF THE DRAWING

FIG. 1 is a schematic view showing a parallel plate CVD apparatus for use in the method of forming an interlayer insulating film according to an embodiment of the present invention.

### DETAILED DESCRIPTION OF THE INVENTION

The present invention is described in detail below.

In the invention, the chemical vapor deposition, which may be referred to as the CVD, is a process of supplying a starting material monomer (a source) for forming the film in the gas state and chemically reacting the monomer to form the film on a substrate. Among the CVD processes, thermal CVD processes are such that a reaction gas is provided on a substrate and heat is applied to cause a chemical reaction, thereby forming a desired film. Further, plasma CVD processes are such that, in a parallel plate plasma CVD apparatus, a 2 cycle excitation type parallel plate plasma apparatus, a high density plasma apparatus, etc., plasma electricity is utilized to promote polymerization of gas monomers, thereby forming a desired film.

The source of the chemical vapor deposition used in the invention is the compound represented by any one of the formulae (Ia) to (Ic) or the composition containing at least the compound represented by any one of the formulae (Ia) to (Ic).

First the compound represented by the following formula (Ia) is described.

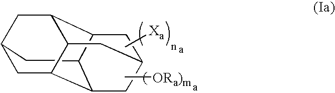

In the formula (Ia), Rₐ represents a hydrogen atom, an alkyl group which preferably has 1 to 10 carbon atoms, or a silyl group which preferably has 0 to 20 carbon atoms.

The alkyl group and the silyl group of Rₐ may have a substituent. Examples of the substituents include halogen atoms such as a fluorine atom, a chlorine atom, a bromine atom, and an iodine atom, alkyl groups, alkenyl groups, alkynyl groups, aryl groups, acyl groups, aryloxy groups, arylsulfonyl groups, a nitro group, a cyano group, silyl groups, etc.

Rₐ is preferably a hydrogen atom, an alkyl group, or a silyl group, more preferably a hydrogen atom, an alkyl group having 1 to 5 carbon atoms, or a silyl group having 0 to 10 carbon atoms, particularly preferably a hydrogen atom.

mₐ is an integer of 1 to 14, preferably an integer of 1 to 4, more preferably an integer of 1 to 3, particularly preferably 2 or 3.

Xₐ represents a halogen atom, an alkyl group which preferably has 1 to 20 carbon atoms, an alkenyl group which preferably has 2 to 10 carbon atoms, an aryl group which preferably has 6 to 20 carbon atoms, or a silyl group which preferably has 0 to 20 carbon atoms. Each of the groups of Xₐ may have a substituent, and examples thereof include those of the substituents of the alkyl and silyl groups of Rₐ. Xₐ is preferably a fluorine atom, a bromine atom, or an alkyl group having 1 to 20 carbon atoms.

nₐ is an integer of 0 to 14, preferably an integer of 0 to 3, more preferably an integer of 0 to 2, particularly preferably 0 or 1.

The compound represented by the formula (Ia) may be such that a plurality of ring skeletons of the formula (Ia) are connected by a single bond.

The molecular weight of the compound represented by the formula (Ia) is preferably 1,000 or less, more preferably 500 or less, particularly preferably 300 or less.

Specific examples of the compounds represented by the formula (Ia) are illustrated below without intention of restricting the scope of the invention.

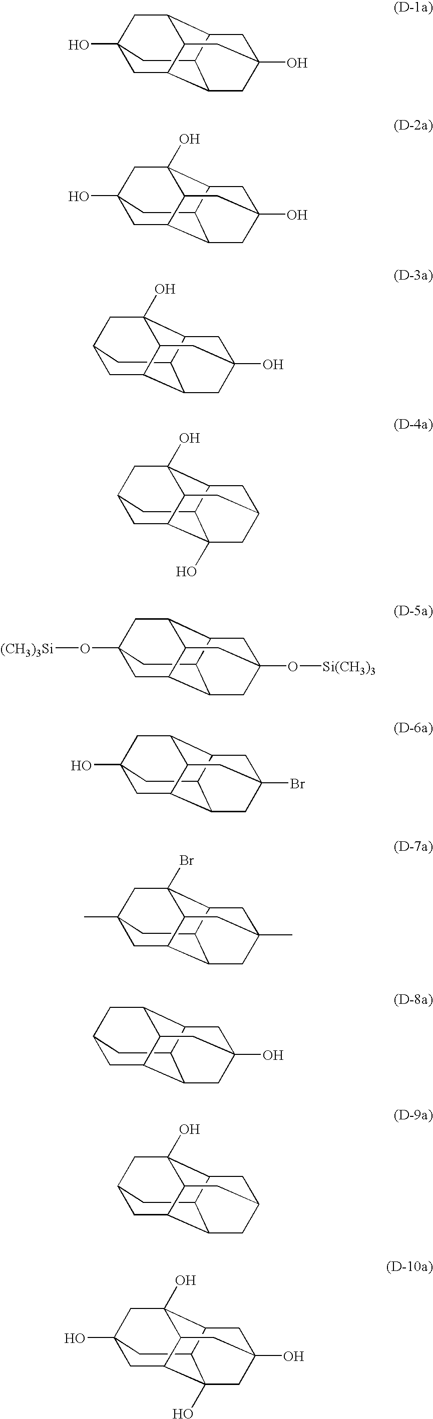

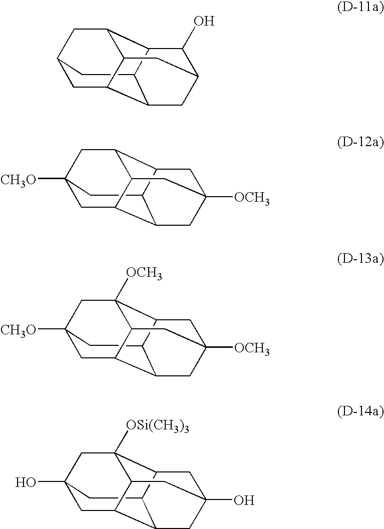

For example, the compound represented by the formula (Ia) can be easily synthesized by preparing a Br derivative in accordance with methods described in Macromolecules, 24, 5266-5268 (1991), and by treating the Br derivative with a 70% nitric acid to substitute Br with an OH group. The OH group can be alkylated or silylated by common methods.

Next the compound represented by the following formula (Ib) is described.

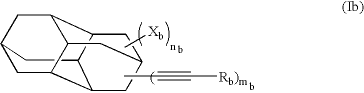

In the formula (Ib), R_{b} represents a hydrogen atom, an alkyl group which preferably has 1 to 10 carbon atoms, an alkenyl group which preferably has 2 to 10 carbon atoms, an alkynyl group which preferably has 2 to 10 carbon atoms, an aryl group which preferably has 6 to 20 carbon atoms, or a silyl group which preferably has 0 to 20 carbon atoms. Each of the groups of R_{b} may have a substituent. Examples of the substituents on R_{b} include halogen atoms such as a fluorine atom, a chlorine atom, a bromine atom, and an iodine atom, alkyl groups, alkenyl groups, alkynyl groups, aryl groups, acyl groups, aryloxy groups, arylsulfonyl groups, a nitro group, a cyano group, silyl groups, etc.

R_{b} is preferably a hydrogen atom, an alkyl group having 1 to 10 carbon atoms, an aryl group having 6 to 20 carbon atoms, or a silyl group having 0 to 20 carbon atoms, more preferably a hydrogen atom, an alkyl group having 1 to 5 carbon atoms, or a silyl group having 0 to 10 carbon atoms, particularly preferably a hydrogen atom.

m_{b} is an integer of 1 to 14, preferably an integer of 1 to 4, more preferably an integer of 1 to 3, particularly preferably 2 or 3.

X_{b} represents a halogen atom, an alkyl group which preferably has 1 to 20 carbon atoms, an alkenyl group which preferably has 2 to 10 carbon atoms, an aryl group which preferably has 6 to 20 carbon atoms, or a silyl group which preferably has 0 to 20 carbon atoms. Each of the groups of X_{b} may have a substituent, and examples thereof include those of the substituents of R_{b}. X_{b} is preferably a fluorine atom, a chlorine atom, a bromine atom, an alkyl group having 1 to 20 carbon atoms, an alkenyl group having 2 to 10 carbon atoms, or a silyl group having 0 to 20 carbon atoms, more preferably a bromine atom, an alkenyl group having 2 to 4 carbon atoms, or a silyl group having 0 to 10 carbon atoms. Further, it is also preferred that X_{b} is a substituted or unsubstituted diamantyl group.

n_{b} is an integer of 0 to 14, preferably an integer of 0 to 3, more preferably an integer of 0 to 2, particularly preferably 0 or 1.

The compound represented by the formula (Ib) may be such that a plurality of ring skeletons of the formula (Ib) are connected by a single bond, like the compounds (D-9b) and (D-10b) exemplified below.

The molecular weight of the compound represented by the formula (Ib) is preferably 1,000 or less, more preferably 500 or less, particularly preferably 300 or less.

Specific examples of the compounds represented by the formula (Ib). are illustrated below without intention of restricting the scope of the invention.

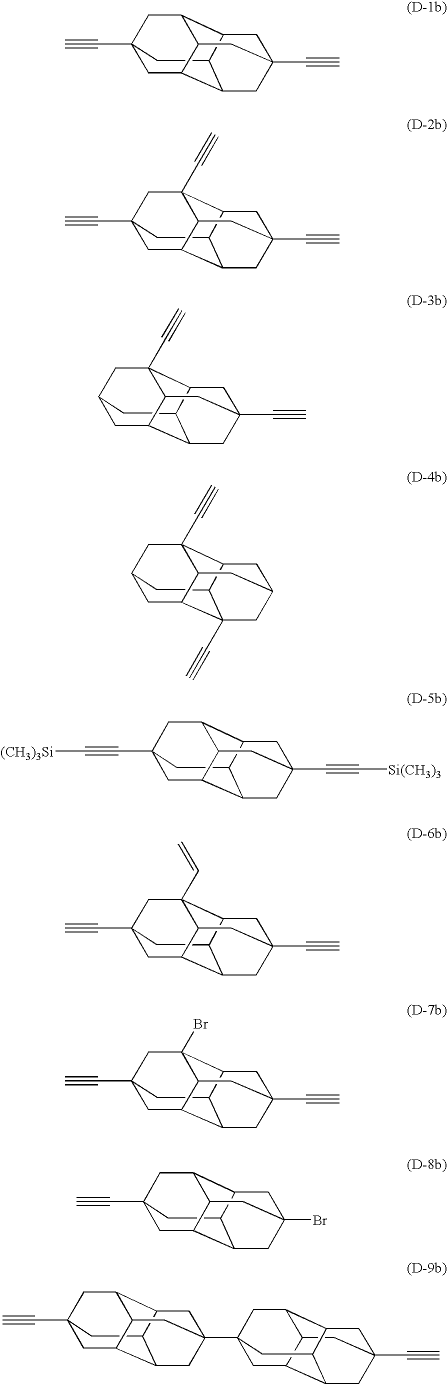

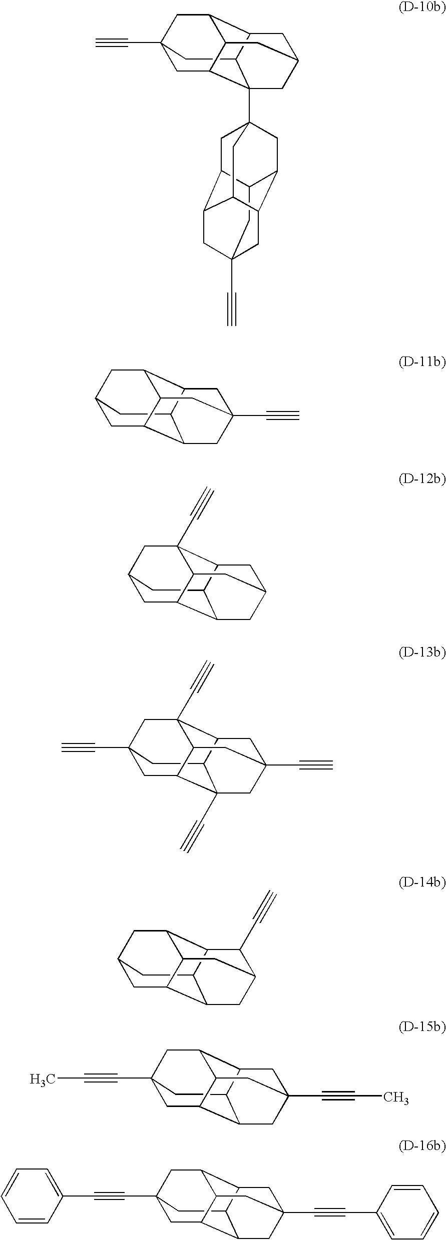

For example, the compound represented by the formula (Ib) can be easily synthesized in accordance with methods described in Macromolecules, 24, 5266-5268 (1991).

Next the compound represented by the following formula (Ic) is described.

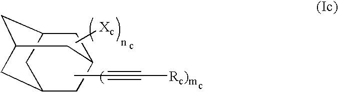

In the formula (Ic), R_{c} represents a hydrogen atom, an alkyl group which preferably has 1 to 10 carbon atoms, an aryl group which preferably has 6 to 20 carbon atoms, or a silyl group which preferably has 0 to 20 carbon atoms.

Each of the groups of R_{c} may have a substituent. Examples of the substituents on R_{c} include halogen atoms such as a fluorine atom, a chlorine atom, a bromine atom, and an iodine atom, alkyl groups, alkenyl groups, alkynyl groups, aryl groups, acyl groups, aryloxy groups, arylsulfonyl groups, a nitro group, a cyano group, silyl groups, etc.

R_{c} is preferably a hydrogen atom, an alkyl group having 1 to 10 carbon atoms, an aryl group having 6 to 20 carbon atoms, or a silyl group having 0 to 20 carbon atoms, more preferably a hydrogen atom, an alkyl group having 1 to 5 carbon atoms, or a silyl group having 0 to 10 carbon atoms, particularly preferably a hydrogen atom.

m_{c} is an integer of 1 to 3, preferably 2 or 3.

X_{c} represents a halogen atom, an alkyl group which preferably has 1 to 20 carbon atoms, an alkenyl group which preferably has 2 to 10 carbon atoms, an aryl group which preferably has 6 to 20 carbon atoms, or a silyl group which preferably has 0 to 20 carbon atoms. Each of the groups of X_{c} may have a substituent, and examples thereof include those of the substituents of R_{c}.

X_{c} is preferably a fluorine atom, a bromine atom, or an alkyl group having 1 to 20 carbon atoms.

n_{c} is an integer of 0 to 9, preferably an integer of 0 to 3, more preferably 0 or 1.

The compound represented by the formula (Ic) may be such that a plurality of ring skeletons of the formula (Ic) are connected by a single bond, like the compound (D-6c) exemplified below.

The molecular weight of the compound represented by the formula (Ic) is preferably 1,000 or less, more preferably 500 or less, particularly preferably 300 or less.

Specific examples of the compounds represented by the formula (Ic) are illustrated below without intention of restricting the scope of the invention.

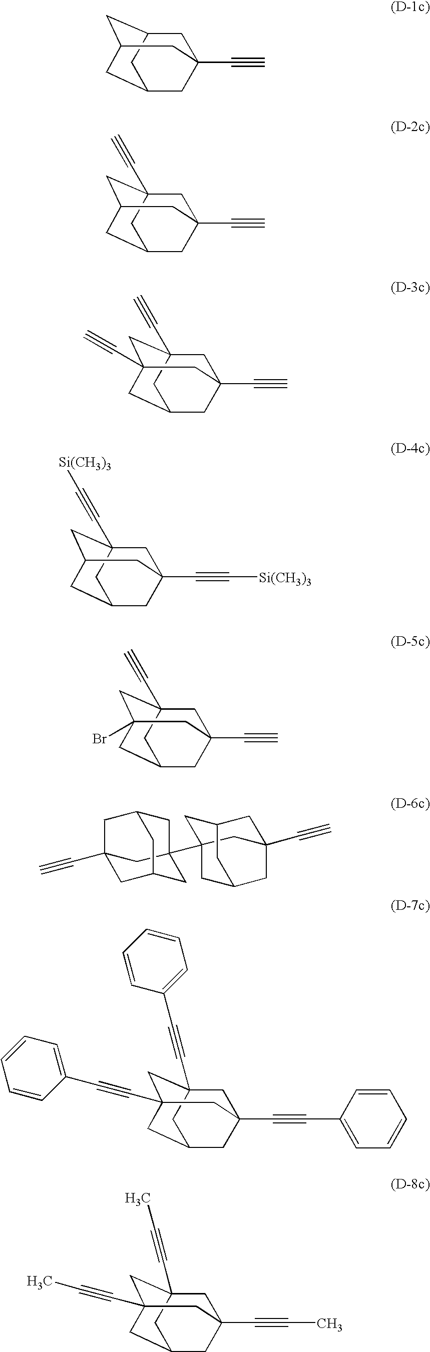

For example, the compound represented by the formula (Ic) can be easily synthesized in accordance with methods described in Journal of Polymer Science: Part A: Polymer Chemistry, vol. 30, 1747-1754 (1992).

The compounds represented by any one of the formulae (Ia) to (Ic) may be used singly or in combination of two or more.

Another monomer such as tetraethoxysilane, methylsilane, dimethylsilane, trimethylsilane, tetramethylsilane, SiH₄, SiF₄, O₂, CF₄, H₂O₂, N₂O, divinyl siloxane benzocyclobutene (DVS-BCB), and parylene monomers may be added to the composition and copolymerized with the above compound in the chemical vapor deposition.

In this case, the total content of the compounds represented by any one of the formulae (Ia) to (Ic) in the composition is preferably 10 to 90% by weight, more preferably 30 to 70% by weight.

The compound or composition used in the invention may be dissolved in an appropriate organic solvent to form a solution for the CVD process. Though not restrictive, preferred examples of the solvents usable in the invention include alcohol solvents such as methanol, ethanol, isopropanol, 1-butanol, 2-ethoxymethanol, and 3-methoxypropanol; ketone solvents such as acetone, acetylacetone, methyl ethyl ketone, methyl isobutyl ketone, 2-pentanone, 3-pentanone, 2-heptanone, 3-heptanone, and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate, and γ-butyrolactone; ether solvents such as diisopropyl ether, dibutyl ether, ethyl propyl ether, anisole, phenetole, and veratrole; aromatic hydrocarbon solvents such as mesitylene, ethylbenzene, diethylbenzene, propylbenzene, and 1,2-dichlorobenzene; amide solvents such as N-methylpyrrolidinone and dimethylacetamide; etc. These solvents may be used singly or as a mixture of two or more.

The content of the compounds represented by any one of the formulae (Ia) to (Ic) of the solution is preferably 1 to 30% by weight, more preferably 5 to 20% by weight.

The chemical vapor deposition source of the compound represented by any one of the formulae (Ia) to (Ic) or the composition containing the compound, which may be dissolved in an organic solvent, may be introduced to a chamber by a pressure of an inert gas such as helium or by heating at e.g. 100 to 300° C. to gasify.

As described above, in the chemical vapor deposition according to the invention, the compound represented by any one of the formulae (Ia) to (Ic) or the composition containing the compound, which is the starting material monomer (the source) for forming the film, is supplied as a gas, and chemically reacted to form the filmona substrate. The process may be referred to as the CVD.

The film is generally a 50-nm- to 5-μm-thick thin film though the thickness of the film is not particularly limited.

Among the CVD processes, thermal CVD processes are such that a reaction gas is provided on a substrate and heat is applied thereto to cause a chemical reaction, thereby forming the desired film. In the case of using the process, the chemical vapor deposition comprises a thermal polymerization reaction. In the invention, the surface temperature of the substrate is preferably 200 to 450° C., more preferably 300 to 400° C., in this process.

Further, plasma CVD processes are such that, in a parallel plate plasma CVD apparatus, a 2 cycle excitation type parallel plate plasma apparatus, a high density plasma apparatus, etc., plasma electricity is utilized to promote polymerization of the gas monomer, thereby forming the desired film. In the case of using the process, the chemical vapor deposition comprises a plasma polymerization reaction.

For example, in the case of using an RF plasma apparatus having parallel plate electrodes with a diameter of 50 cm faced at a 20 cm interval in the CVD process, it is preferred that the RF plasma voltage be 50 to 700 W, whereby the monomer is sufficiently crosslinked in the film formation and the substrate can be prevented from deterioration due to excessively high plasma output.

Further, any chemical vapor deposition process, such as a combination of the thermal CVD process and the plasma CVD process, may be used in the invention.

### EXAMPLES

The following Examples are for purposes of further explaining the present invention, not restricting the scope of the invention.

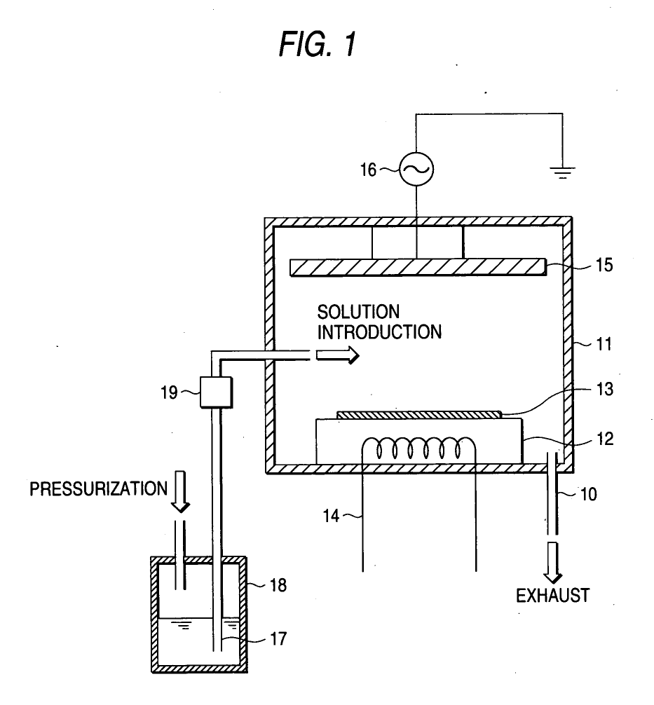

As an example of the chemical vapor deposition apparatus, a parallel plate CVD apparatus is schematically described with reference to FIG. 1. As shown in FIG. 1, a sample support 12 of a lower electrode is disposed in the lower portion of a chamber 11, which is maintained in the vacuum state by an evacuation system 10, and a semiconductor wafer 13 is disposed on the sample support 12. The sample support 12 has a heating unit 14. A counter electrode 15 is disposed in the upper portion of the chamber 11, and a high frequency power is applied by high frequency power source 16 to the counter electrode 15 to achieve plasma discharge in the chamber 11. When helium gas is supplied to a pressurized vessel 18 containing a solution 17, the solution 17 is introduced by the pressure of the helium gas through a mass flow 19 to the chamber 11.

<Thermal CVD Process>

### (Examples 1 to 11)

10 g of the compounds of the invention shown in Table 1 were dissolved in 100 ml of mesitylene to prepare the solution 17. The solution 17 was added to the pressurized vessel 18, and then introduced to the chamber 11 of the CVD apparatus by the helium gas pressure. The solution 17 was introduced to the chamber 11 at 10 ml/min while controlling the inner pressure of the chamber 11 at 665 Pa and using a helium gas as a dilution gas. Further, the temperature of the semiconductor wafer 13 fixed on the sample support 12 was adjusted to 400° C. by the heating unit 14. When treated for 3 minutes under these conditions, a low-dielectric film having a thickness of 250 nm was deposited on the semiconductor wafer 13. The relative dielectric constants of the resultant samples 1 to 11 were measured by CV measurement using an Hg probe, and the results are shown in Table 1.

### (Comparative Example 1)

A comparative sample 1 was produced in the same manner as Examples 1 to 11 except for using 1,3,5-trihydroxyadamantane instead of the compounds of the invention. The result of measuring the relative dielectric constant of the sample is shown in Table 1.

TABLE 1

| | | Relative |
|---|---|---|
| | | dielectric |
| | Compound | constant |
| Example 1 | D-1a | 2.36 |
| 2 | D-2a | 2.36 |
| 3 | D-1a (5 g) + D-2a (5 g) | 2.36 |
| 4 | D-4a | 2.36 |
| 5 | D-1b | 2.35 |
| 6 | D-2b | 2.35 |
| 7 | D-1b (5 g) + D-2b (5 g) | 2.35 |
| 8 | D-4b | 2.35 |
| 9 | D-1c | 2.37 |
| 10 | D-2c | 2.36 |
| 11 | D-3c | 2.36 |
| Comparative | 1,3,5-Trihydroxyadamantane | 2.45 |
| Example 1 | | |

### (Examples 12 to 22)

The pressurized vessel 18 shown in FIG. 1 was replaced by a sample chamber equipped with a heater (not shown), and the compounds of the invention shown in Table 2 were put in the sample chamber, and sublimated and gasified by heating the sample chamber to 200° C. After the gasification was stabilized, the inner pressure of the chamber 11 was controlled at 665 Pa, and the gas was introduced into the chamber at the flow rate of 50 sccm. At the same time the temperature of the semiconductor wafer 13 fixed on the sample support 12 was adjusted to 400° C. by the heating unit 14, so that a low-dielectric film having a thickness of 250 nm was deposited on the semiconductor wafer 13 to produce samples 12 to 22. The relative dielectric constants of the resultant samples were measured by CV measurement using an Hg probe, and the results are shown in Table 2.

### (Comparative Example 2)

A comparative sample 2 was produced in the same manner as Examples 12 to 22 except for using 1,3,5-trihydroxyadamantane instead of the compounds of the invention. The result of measuring the relative dielectric constant of the sample is shown in Table 2.

TABLE 2

| | | Relative |
|---|---|---|
| | | dielectric |
| | Compound | constant |
| Example 12 | D-1a | 2.36 |
| 13 | D-2a | 2.36 |
| 14 | D-1a (5 g) + D-2a (5 g) | 2.36 |
| 15 | D-4a | 2.36 |
| 16 | D-1b | 2.35 |
| 17 | D-2b | 2.35 |
| 18 | D-1b (5 g) + D-2b (5 g) | 2.35 |
| 19 | D-4b | 2.35 |
| 20 | D-1c | 2.37 |
| 21 | D-2c | 2.36 |
| 22 | D-3c | 2.36 |
| Comparative | 1,3,5-Trihydroxyadamantane | 2.45 |
| Example 2 | | |

It is clear from the results shown in Tables 1 and 2 that the sufficiently low relative dielectric constants can be obtained by using the compounds and compositions according to the invention.

<Plasma CVD Process>

### (Example 23)

A high frequency power of e.g. 13.56 MHz was applied at 50 W to the plate-shaped counter electrode 15 while grounding the sample support 12, whereby a film was formed under plasma discharge. The other conditions are the same as in the thermal CVD process. In the case of thus using the plasma CVD process for polymerization, the film formation speed was increased by 1.5 times or more. Further, the films obtained by the process had dielectric constants equal to those of Tables 1 and 2.

The film of the present invention is a low-dielectric insulating film, and can be used as an interlayer insulating film of electronic devices, etc.

The entire disclosure of each and every foreign patent application from which the benefit of foreign priority has been claimed in the present application is incorporated herein by reference, as if fully set forth.

What is claimed is:

1. A film obtained by a chemical vapor deposition of a compound represented by any one of formula (Ia) to (Ic) or a composition containing at least the compound represented by any one of formula (Ia) to (Ic): 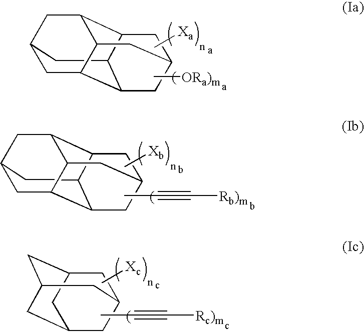
in formula (Ia), Rₐ represents a hydrogen atom, an alkyl group or a silyl group;
mₐ represents an integer of 1 to 14;
Xₐ represents a halogen atom, an alkyl group, an alkenyl group, an aryl group or a silyl group; and
nₐ represents an integer of 0 to 14, and when a compound includes a plurality of Rₐ's or a plurality of Xₐ's, the plurality of Rₐ's or the plurality of Xₐ's may be the same or different respectively,
in formula (Ib), R_{b} represents a hydrogen atom, an alkyl group, an alkenyl group, an alkynyl group, an aryl group or a silyl group;
m_{b} represents an integer of 1 to 14;
X_{b} represents a halogen atom, an alkyl group, an alkenyl group, an aryl group or a silyl group; and
n_{b} represents an integer of 0 to 14, and when a compound includes a plurality of R_{b}'s or a plurality of X_{b}'s, the plurality of R_{b}'s or the plurality of X_{b}'s may be the same or different respectively,
in formula (Ic), R_{c} represents a hydrogen atom, an alkyl group, an aryl group or a silyl group;
m_{c} represents an integer of 1 to 3;
X_{c} represents a halogen atom, an alkyl group, an alkenyl group, an aryl group or a silyl group; and
n_{c} represents an integer of 0 to 9, and when a compound includes a plurality of R_{c}'s or a plurality of X_{c}'s, the plurality of R_{c}'s or the plurality of X_{c}'s may be the same or different respectively.

2. The film according to claim 1,
wherein the chemical vapor deposition comprises a thermal polymerization reaction of the compound represented by any one of formula (Ia) to (Ic).

3. The film according to claim 1,
wherein the chemical vapor deposition comprises a plasma polymerization reaction of the compound represented by any one of formula (Ia) to (Ic).
